(19) United States
(12) Patent Application Publication
(10) Pub. No.: US 2023/0043083 A1
(43) Pub. Date: Feb. 9, 2023

(54) Cleaning Device For Removing Hair And/Or Debris From A Rotary Brush And A Method Using The Same

(71) Applicants: Stephen S. Turner, Edelstein, IL (US); Scott I. Turner, Chillicothe, IL (US)

(72) Inventors: Stephen S. Turner, Edelstein, IL (US); Scott I. Turner, Chillicothe, IL (US)

(21) Appl. No.: 17/881,537

(22) Filed: Aug. 4, 2022

Related U.S. Application Data
(60) Provisional application No. 63/229,465, filed on Aug. 4, 2021.
(60) Provisional application No. 63/257,915, filed on Oct. 20, 2021.

(51) Int. Cl. A47L 11/40

(52) U.S. Cl. CPC A47L 11/4027

(57) ABSTRACT

A cleaning device for removing hair and/or debris from a rotary brush and a method using the same are disclosed herein. The cleaning device includes an elongated rod having a first end, a second end, and a rod axis, the first end of the elongated rod being oppositely disposed relative to the second end of the elongated rod, the elongated rod further including a plurality of protruding elements projecting outwardly from the elongated rod, the plurality of protruding elements being disposed at least partially around a periphery of the elongated rod and along at least a portion of a length of the elongated rod between the first end and the second end. The first end of the elongated rod is configured to be coupled to a rotary motion input device that is sufficient to rotate the plurality of protruding elements of the elongated rod about the rod axis.

### CROSS-REFERENCE TO RELATED APPLICATIONS

This patent application claims priority to U.S. Provisional Patent Application No. 63/229,465, entitled “Cleaning Device For Removing Hair And/Or Debris From A Rotary Brush And A Method Using The Same”, filed on Aug. 4, 2021, and U.S. Provisional Patent Application No. 63/257,915, entitled “Power Tool Adapter For A Drain Cleaning Device”, filed on Oct. 20, 2021, the disclosure of each of which is hereby incorporated by reference as if set forth in their entirety herein.

### STATEMENT REGARDING FEDERALLY SPONSORED RESEARCH OR DEVELOPMENT

Not Applicable.

### NAMES OF THE PARTIES TO A JOINT RESEARCH AGREEMENT

Not Applicable.

### INCORPORATION BY REFERENCE OF MATERIAL SUBMITTED ON A COMPACT DISK

Not Applicable.

### BACKGROUND OF THE INVENTION

### 1. Field of the Invention

The invention generally relates to a cleaning device for removing hair and/or debris from a rotary brush and a method using the same. More particularly, the invention relates to a cleaning device for removing hair and/or debris from a rotary brush of a vacuum cleaner.

### 2. Background

Vacuum cleaners are found in virtually every household since floors continually accumulate dirt, pet hair, and other fibrous material. The apparatus on a typical vacuum that spins against the floor to dislodge and pick up debris in concert with vacuum suction is called the vacuum roller brush. These rollers will get hair and carpet threads and fibers wrapped perpendicularly onto the roller and eventually clog the roller completely if not cleaned off occasionally. The most common solution to clean the roller is to use scissors or a knife-type tool, such as a sewing seam ripper, which works like a letter opener by running the tool along the roller in multiple passes until all the hair and thread debris is cut away from the roller. The user then has to laboriously pick off the cut debris by hand which is a time consuming and sometimes dangerous endeavor.

Therefore, what is needed is a cleaning device and a method using the same that is able to easily and safely remove hair and/or debris from a rotary brush, such as a vacuum roller brush.

### BRIEF SUMMARY OF EMBODIMENTS OF THE INVENTION

Accordingly, the present invention is directed to a cleaning device for removing hair and/or debris from a rotary brush and a method using the same that substantially obviates one or more problems resulting from the limitations and deficiencies of the related art.

In accordance with one or more embodiments of the present invention, there is provided a cleaning device for removing hair and/or debris from a rotary brush. The cleaning device includes an elongated rod having a first end, a second end, and a rod axis, the first end of the elongated rod being oppositely disposed relative to the second end of the elongated rod, the elongated rod further including a plurality of protruding elements projecting outwardly from the elongated rod, the plurality of protruding elements being disposed at least partially around a periphery of the elongated rod and along at least a portion of a length of the elongated rod between the first end and the second end. In these one or more embodiments, the first end of the elongated rod is configured to be coupled to a rotary motion input device that is sufficient to rotate the plurality of protruding elements of the elongated rod about the rod axis; and upon the elongated rod being rotated by the rotary motion input device, the plurality of protruding elements are configured to grab and collect the hair and/or debris from the rotary brush so as to clean the rotary brush.

In a further embodiment of the present invention, the rotary motion input device for rotating the elongated rod is selected from the group consisting of: (i) a drill, (ii) a screwdriver, (iii) a power drill, (iv) a power screwdriver, and (v) a hand crank.

In yet a further embodiment, the elongated rod further comprises a central core portion and an outer covering bonded to the central core portion, the outer covering formed from a hook material strip, the hook material strip comprising the plurality of protruding elements of the elongated rod, and the hook material strip being made from a hook side of a hook-and-loop fastener material.

In still a further embodiment, the central core portion is formed from a semi-flexible cable, the semi-flexible cable comprising a plurality of inner wires surrounded by an outer sheathing, the hook material strip being bonded to the outer sheathing of the semi-flexible cable.

In yet a further embodiment, the central core portion is formed from a plastic core.

In still a further embodiment, the plurality of protruding elements of the elongated rod are in the form of a plurality of injection-molded micro-hook elements.

In yet a further embodiment, at least some of the plurality of injection-molded micro-hook elements are in the form of inverted J-shaped projections projecting outwardly from the elongated rod.

In still a further embodiment, at least some of the plurality of injection-molded micro-hook elements are in the form of T-shaped projections projecting outwardly from the elongated rod.

In yet a further embodiment, the rotary brush is a rotary brush in a vacuum cleaner.

In still a further embodiment, the cleaning device is configured to be discarded after being used to remove the hair and/or debris from the rotary brush; the cleaning device is configured to be trimmed and reused after being used to remove the hair and/or debris from the rotary brush; or the cleaning device is configured to be flipped end-for-end and reused after being used to remove the hair and/or debris from the rotary brush.

In yet a further embodiment, the cleaning device further comprises a power tool adapter configured to couple the first end of the elongated rod section to the rotary motion input device, the power tool adapter includes an adapter body with a shank section for being inserted into a recess of the rotary motion input device.

In still a further embodiment, the rotary motion input device is in a form of a manual handle assembly, the manual handle assembly configured to be detachably coupled to the elongated rod so that the cleaning device is able to be discarded after being used to remove the hair and/or debris from the rotary brush.

In accordance with one or more other embodiments of the present invention, there is provided a cleaning device for removing hair and/or debris from a rotary brush. The cleaning device includes an elongated rod having a first end, a second end, and a rod axis, the first end of the elongated rod being oppositely disposed relative to the second end of the elongated rod, the elongated rod further including a plurality of protruding elements projecting outwardly from the elongated rod, the plurality of protruding elements being disposed at least partially around a periphery of the elongated rod and along at least a portion of a length of the elongated rod between the first end and the second end; and a rotary motion input device coupled to the first end of the elongated rod, the rotary motion input device configured to rotate the elongated rod about the rod axis. In these one or more embodiments, upon the elongated rod being rotated by the rotary motion input device about the rod axis, the plurality of protruding elements of the elongated rod are configured to grab and collect the hair and/or debris from the rotary brush so as to clean the rotary brush.

In a further embodiment of the present invention, the rotary motion input device is selected from the group consisting of: (i) a drill, (ii) a screwdriver, (iii) a power drill, (iv) a power screwdriver, and (v) a hand crank.

In yet a further embodiment, the elongated rod further comprises a central core portion and an outer covering bonded to the central core portion, the outer covering formed from a hook material strip, the hook material strip comprising the plurality of protruding elements of the elongated rod, and the hook material strip being made from a hook side of a hook-and-loop fastener material.

In still a further embodiment, the central core portion is formed from a semi-flexible cable, the semi-flexible cable comprising a plurality of inner wires surrounded by an outer sheathing, the hook material strip being bonded to the outer sheathing of the semi-flexible cable.

In yet a further embodiment, the central core portion is formed from a plastic core.

In still a further embodiment, the rotary brush is a rotary brush in a vacuum cleaner.

In yet a further embodiment, the cleaning device further comprises a power tool adapter configured to couple the first end of the elongated rod section to the rotary motion input device, the power tool adapter includes an adapter body with a shank section for being inserted into a recess of the rotary motion input device.

In still a further embodiment, the rotary motion input device is in a form of a manual handle assembly, the manual handle assembly configured to be detachably coupled to the elongated rod so that the cleaning device is able to be discarded after being used to remove the hair and/or debris from the rotary brush.

In accordance with yet one or more other embodiments of the present invention, there is provided a method of removing hair and/or debris from a rotary brush. The method includes the steps of: (i) providing a cleaning device for removing hair and/or debris from a rotary brush; (ii) providing a rotary brush having hair and/or debris therein or thereon; (iii) rotating, by using rotary motion input device, the elongated rod of the cleaning device about the rod axis; and (iv) engaging the plurality of protruding elements of the elongated rod of the cleaning device with the hair and/or debris in or on the rotary brush so as to clean the rotary brush. The cleaning device includes an elongated rod having a first end, a second end, and a rod axis, the first end of the elongated rod being oppositely disposed relative to the second end of the elongated rod, the elongated rod further including a plurality of protruding elements projecting outwardly from the elongated rod, the plurality of protruding elements being disposed at least partially around a periphery of the elongated rod and along at least a portion of a length of the elongated rod between the first end and the second end; and a rotary motion input device coupled to the first end of the elongated rod, the rotary motion input device configured to rotate the elongated rod about the rod axis.

In a further embodiment of the present invention, the rotary motion input device for rotating the elongated rod is selected from the group consisting of: (i) a drill, (ii) a screwdriver, (iii) a power drill, (iv) a power screwdriver, and (v) a hand crank.

In yet a further embodiment, the elongated rod of the cleaning device further comprises a central core portion and an outer covering bonded to the central core portion, the outer covering formed from a hook material strip, the hook material strip comprising the plurality of protruding elements of the elongated rod, and the hook material strip being made from a hook side of a hook-and-loop fastener material.

In still a further embodiment, the rotary brush is a rotary brush in a vacuum cleaner.

It is to be understood that the foregoing general description and the following detailed description of the present invention are merely exemplary and explanatory in nature. As such, the foregoing general description and the following detailed description of the invention should not be construed to limit the scope of the appended claims in any sense.

### BRIEF DESCRIPTION OF THE SEVERAL VIEWS OF THE DRAWINGS

The invention will now be described, by way of example, with reference to the accompanying drawings, in which:

FIG. 1 is a perspective view of a cleaning device mounted on a drill, according to an illustrative embodiment of the invention, the cleaning device configured to remove hair and/or debris from a rotary brush when rotated by the drill;

FIG. 2 is another perspective view of the cleaning device of FIG. 1 mounted on the drill, the cleaning device contains hair and/or debris thereon after being used to clean a rotary brush, and additional cleaning devices are illustrated next to the drill;

FIG. 3 is a perspective view of the cleaning device of FIG. 1;

FIG. 4 is a perspective view of a first exemplary central core portion of the cleaning device of FIG. 1;

FIG. 5 is an end view of the cleaning device of FIG. 1 illustrating the outer covering of the cleaning device bonded to the first exemplary central core portion;

FIG. 6 illustrates a first exemplary wire configuration for the central core portion of the cleaning device of FIG. 1;

FIG. 7 illustrates a second exemplary wire configuration for the central core portion of the cleaning device of FIG. 1;

FIG. 8 is an end view depicting a cleaning device having a second exemplary central core portion, according to another illustrative embodiment of the invention;

FIG. 9 illustrates different types of central core portions that may be used in the cleaning device of FIG. 8;

FIG. 10 is an end view of the cleaning device of FIG. 8 which illustrates the end of the cleaning device being terminated by dipping the end in glue or plastic;

FIG. 11 is an end view of the cleaning device of FIG. 1 which illustrates the end of the cleaning device being terminated by soldering the wires of the central core portion;

FIG. 12 is a first perspective view of the cleaning device and drill of FIG. 1 being used to clean the rotary brush of a vacuum cleaner;

FIG. 13 is a second perspective view of the cleaning device and drill of FIG. 1 being used to clean the rotary brush of a vacuum cleaner;

FIG. 14 is a perspective view of a cleaning device mounted on a first type of manual handle assembly, according to another illustrative embodiment of the invention, the cleaning device configured to remove hair and/or debris from a rotary brush when a user rotates the handle of the manual handle assembly;

FIG. 15 is a side view of the cleaning device mounted on the manual handle assembly of FIG. 14;

FIG. 16 is a perspective view of the handle collet subassembly of the manual handle assembly of FIG. 14;

FIG. 17 is a side view of the handle collet subassembly of the manual handle assembly of FIG. 14;

FIG. 18 is a perspective view of the sleeve of the manual handle assembly of FIG. 14;

FIG. 19 is a side view of the sleeve of the manual handle assembly of FIG. 14;

FIG. 20 is a perspective view of the mandrel of the manual handle assembly of FIG. 14;

FIG. 21 is a side view of the mandrel of the manual handle assembly of FIG. 14;

FIG. 22 is an end view of the mandrel of the manual handle assembly of FIG. 14;

FIG. 23 is a perspective view of a cleaning device that includes a power tool adapter, according to yet another illustrative embodiment of the invention, the cleaning device configured to remove hair and/or debris from a rotary brush when rotated by a power tool;

FIG. 24 is a rear elevational view of the cleaning device with the power tool adapter of FIG. 23;

FIG. 25 is a first side elevational view of the cleaning device with the power tool adapter of FIG. 23;

FIG. 26 is a second side elevational view of the cleaning device with the power tool adapter of FIG. 23;

FIG. 27 is a top plan view of the cleaning device with the power tool adapter of FIG. 23;

FIG. 28 is a bottom plan view of the cleaning device with the power tool adapter of FIG. 23;

FIG. 29 is a front elevational view of the cleaning device with the power tool adapter of FIG. 23;

FIG. 30 is a longitudinal sectional view cut through the cleaning device and the power tool adapter of FIG. 23, wherein the section is generally cut along the cutting-plane line A-A in FIG. 24;

FIG. 31 is an exploded perspective view of the cleaning device and the power tool adapter of FIG. 23;

FIG. 32 is a perspective view of a cleaning device mounted on a second type of manual handle assembly, according to still another illustrative embodiment of the invention, the cleaning device configured to remove hair and/or debris from a rotary brush when a user rotates the handle of the manual handle assembly;

FIG. 33 is a rear elevational view of the cleaning device mounted on the manual handle assembly of FIG. 32;

FIG. 34 is a first side elevational view of the cleaning device mounted on the manual handle assembly of FIG. 32;

FIG. 35 is a second side elevational view of the cleaning device mounted on the manual handle assembly of FIG. 32;

FIG. 36 is a top plan view of the cleaning device mounted on the manual handle assembly of FIG. 32;

FIG. 37 is a bottom plan view of the cleaning device mounted on the manual handle assembly of FIG. 32;

FIG. 38 is a front elevational view of the cleaning device mounted on the manual handle assembly of FIG. 32;

FIG. 39 is a longitudinal sectional view cut through the cleaning device and the manual handle assembly of FIG. 32, wherein the section is generally cut along the cutting-plane line B-B in FIG. 33; and

FIG. 40 is an exploded perspective view of the cleaning device and the manual handle assembly of FIG. 32.

Throughout the figures, the same parts are always denoted using the same reference characters so that, as a general rule, they will only be described once.

### DETAILED DESCRIPTION OF EMBODIMENTS OF THE INVENTION

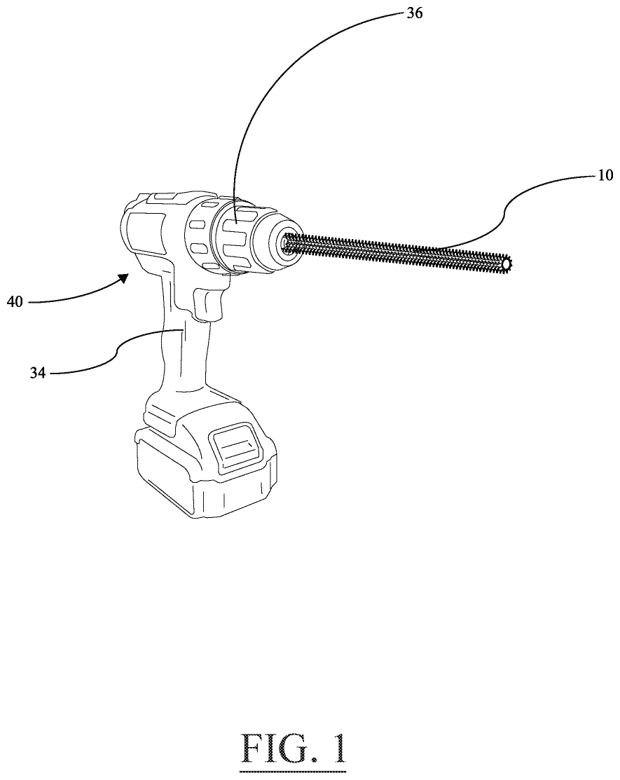

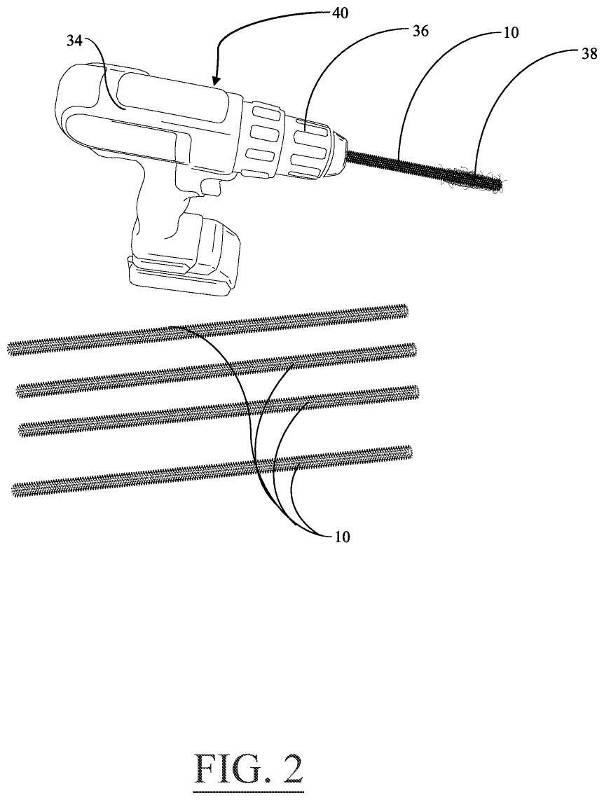

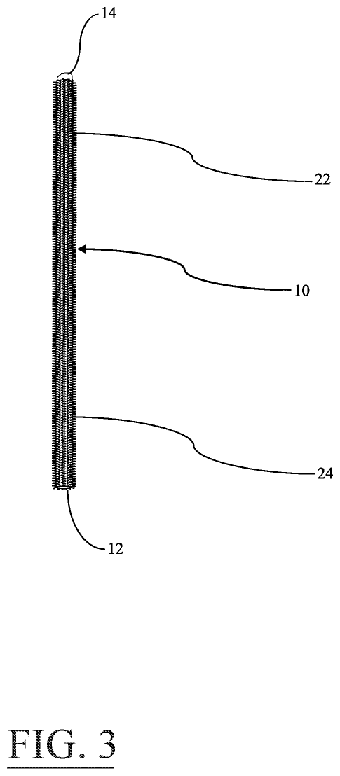

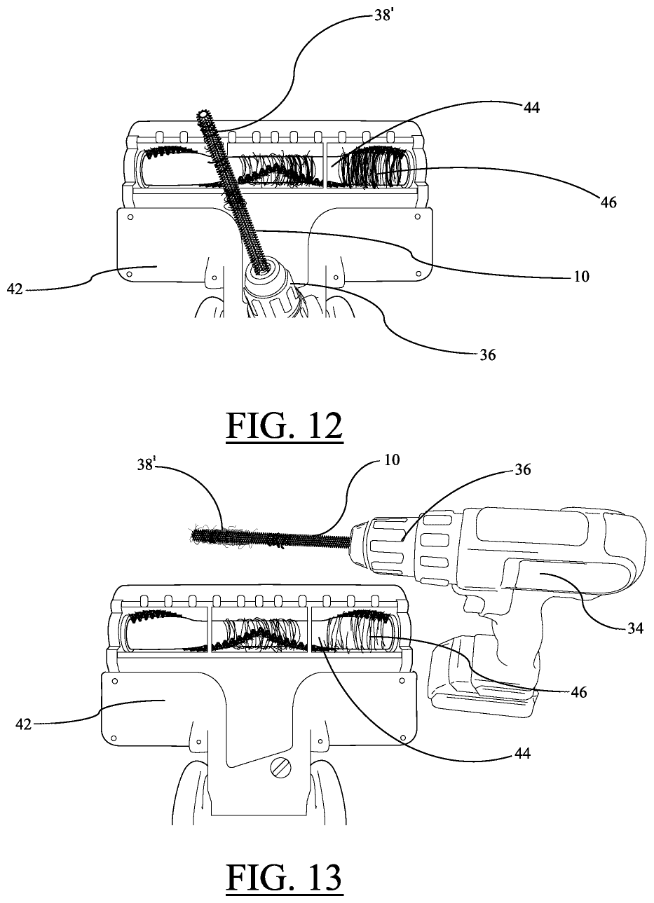

A first illustrative embodiment of a cleaning device is seen generally at 10 in FIGS. 1-3 and 11. The cleaning device 10 is used for removing hair and/or debris from a rotary brush (e.g., from a vacuum roller brush). With initial reference to FIG. 3, it can be seen that the cleaning device 10 generally comprises an elongated rod having a first end 12, a second end 14, and a rod axis, the first end 12 of the elongated rod being oppositely disposed relative to the second end 14 of the elongated rod, the elongated rod further including a plurality of protruding elements 24 projecting outwardly from the elongated rod, the plurality of protruding elements 24 being disposed at least partially around a periphery of the elongated rod and along at least a portion of a length of the elongated rod between the first end 12 and the second end 14. As shown in FIGS. 1 and 2, the first end 12 of the elongated rod is configured to be coupled to a rotary motion input device (e.g., a battery-powered drill 34) that is sufficient to rotate the plurality of protruding elements 24 of the elongated rod about the rod axis; and upon the elongated rod being rotated by the rotary motion input device (e.g., the drill 34), the plurality of protruding elements 24 are configured to grab and collect the hair and/or debris from a rotary brush so as to clean the rotary brush (e.g., a rotary brush 44 of a vacuum cleaner 42—see FIGS. 12 and 13).

As shown in FIGS. 1 and 2, in the first illustrative embodiment, the rotary cleaning system 40 comprises the cleaning device 10 and the drill 34. As such, in the first illustrative embodiment, the battery-powered drill 34 forms the rotary motion input device of the powered rotary cleaning system 40. In FIGS. 1 and 2, it can be seen that the first end 12 of the elongated rod of the cleaning device 10 is coupled to the chuck 36 of the battery-powered drill 34 so that the drill 34 rotates the elongated rod of the cleaning device 10 about the rod axis.

While a battery-powered drill 34 serves as the rotary motion input device for the rotary cleaning system 40 of the first illustrative embodiment, it is to be understood that various other rotary motion input devices may be used, such as a manual drill, a manual screwdriver, a power screwdriver, and a hand crank. For example, a manual rotary cleaning system 48 that utilizes a manual handle assembly 50 will be described hereinafter with regard to the second illustrative embodiment of the rotary cleaning system.

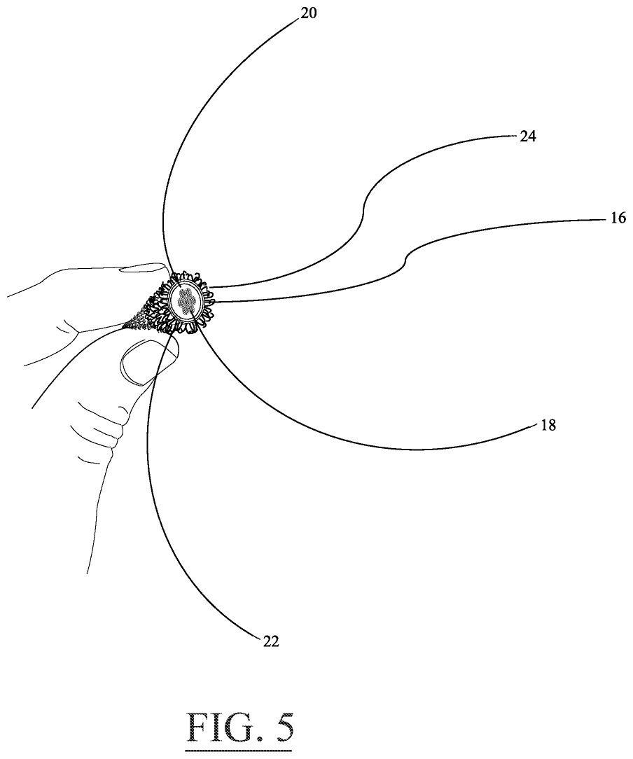

Now, with combined reference to FIGS. 3-5, additional features of the illustrative cleaning device 10 will be explained. As best shown in the end view of FIG. 5, the elongated rod of the cleaning device 10 further comprises a central core portion 16 and an outer covering 22 bonded to the central core portion 16. In the illustrative embodiment, the outer covering 22 is formed from a hook material strip. More specifically, in the illustrative embodiment, the hook material strip is made from a hook portion of a hook-and-loop fastener material (e.g., made from the hook portion of Velcro®). As such, in the illustrative embodiment, the hook elements of the hook material strip (e.g., the hook portion of Velcro®) form the plurality of protruding elements 24 of the elongated rod of the cleaning device 10.

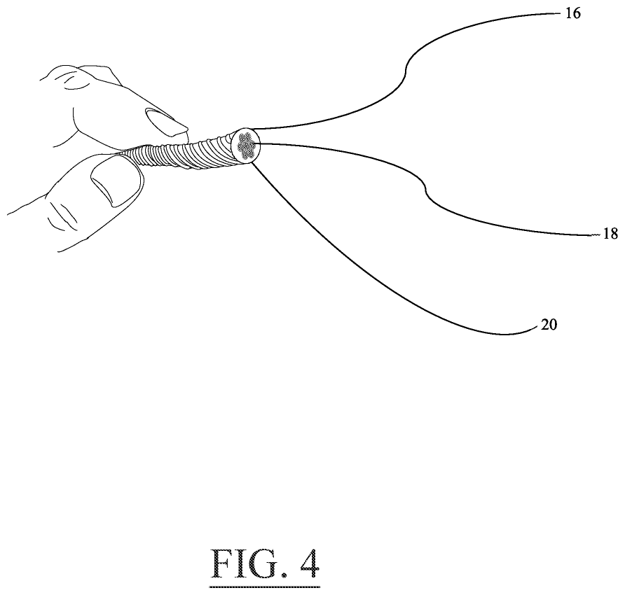

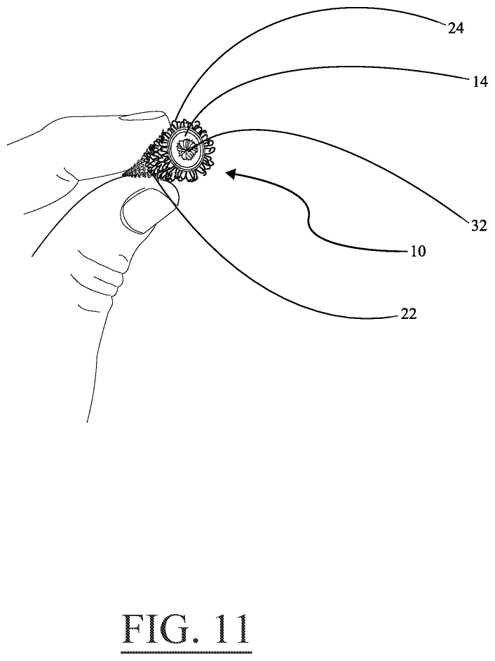

Referring again to the end view of FIG. 5, it can be seen that, in the illustrative embodiment of FIGS. 1-5, the central core portion 16 of the cleaning device 10 is formed from a semi-flexible cable. In the illustrative embodiment, as best shown in FIG. 4, the semi-flexible cable 16 comprises a plurality of inner metal wires 18 surrounded by an outer plastic sheathing 20. In the illustrative embodiment, the hook material strip 22 is bonded to the outer plastic sheathing 20 of the semi-flexible cable 16 (e.g., the hook portion of Velcro® is glued onto the outer plastic sheathing 20 of the cable 16). As shown in FIG. 11, one or more ends 14 of the central core portion 16 of the cleaning device 10 may be terminated by soldering 32 the inner metal wires 18 of the central core portion 16 so as to avoid loose protruding wires, and to give a more finished appearance to the cleaning device 10.

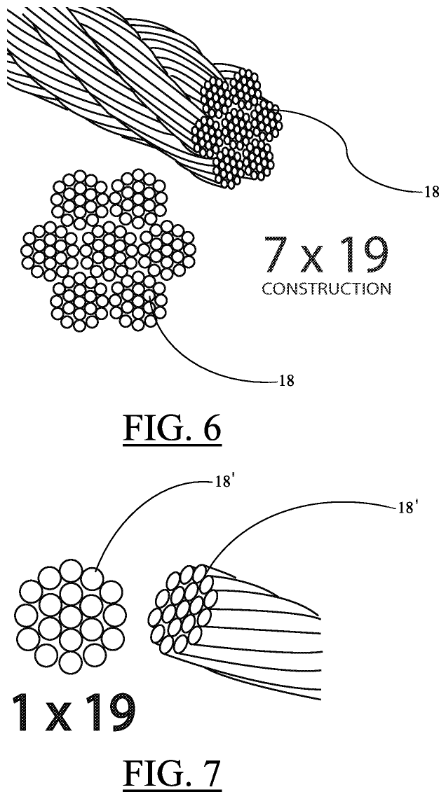

In the illustrative embodiment of FIGS. 3-5, the semi-flexible cable, which is used for the central core portion 16 of the cleaning device 10, comprises plastic-coated aircraft cable with a 7/32 inch diameter and a 7×19 wire configuration (see FIG. 6). In other embodiments, other types of cable are used for the central core portion 16 of the cleaning device 10. For example, with reference to FIG. 7, the semi-flexible cable that is used for the central core portion 16 of the cleaning device 10 may have a different wire configuration 18′ (e.g., a 1×19 wire configuration). The wire configuration 18′ of FIG. 7 results in a stiffer wire core portion 16 with fewer strands of wires.

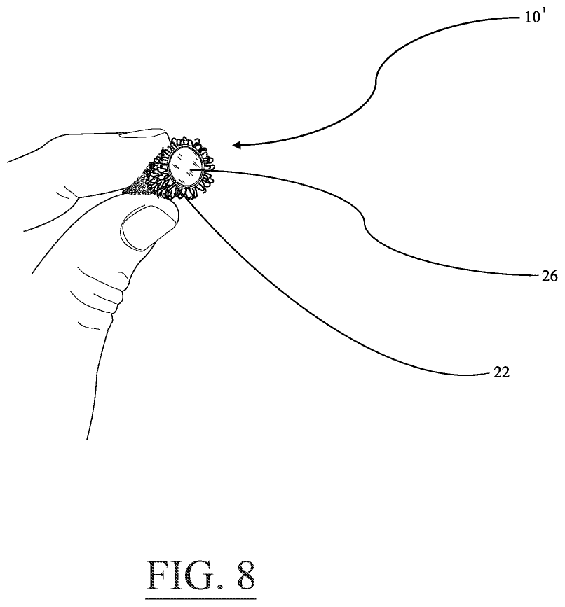

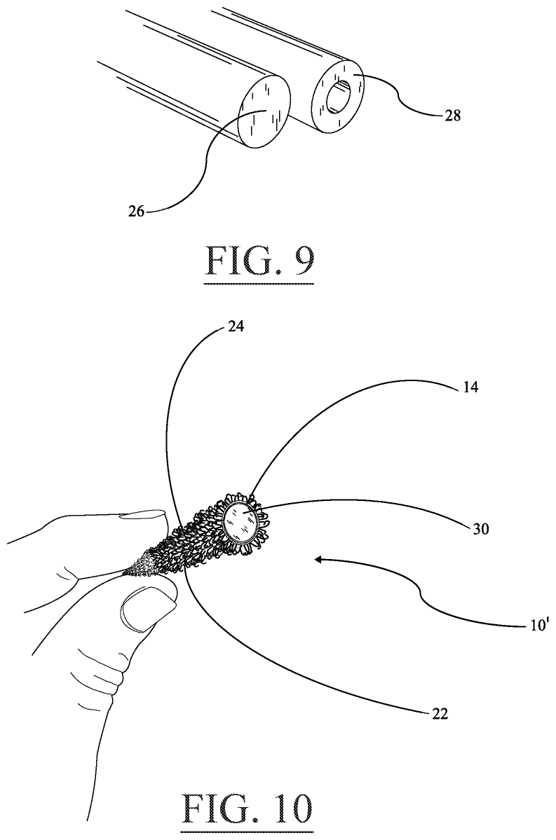

Next, with reference to the illustrative embodiment of FIGS. 8-10, a second type of central core portion that may be used in the cleaning device 10 will be described. Initially, as shown in FIG. 8, the central core portion of the cleaning device 10′ is formed from a plastic core 26, rather than the semi-flexible cable 16 described above. For example, the plastic core version of the cleaning device 10′ may be used for applications where a more rigid elongated rod is needed. Different types of plastic cores 26, 28 that may be used for the cleaning device 10′ are shown in FIG. 9. In the illustrative embodiments utilizing a plastic core, the hook material strip 22 is bonded to the outer periphery of the plastic core 26, 28 (e.g., the hook portion of Velcro® is glued onto the outer periphery of the plastic core 26, 28). As shown in FIG. 10, one or more ends 14 of the plastic core 26, 28 of the cleaning device 10′ may be terminated by dipping the end 14 of the cleaning device 10′ in glue or plastic 30 so as to avoid sharp edges, and to give a more finished appearance to the cleaning device 10′.

In the illustrative embodiments described above, the cleaning device 10, 10′ comprises a rotatable rod of proper diameter and flexibility, which is wrapped with an outer layer of the hook portion of woven, hook-and-loop fastener textile material. The cleaning sticks 10, 10′ are inserted into a rotational appliance such as a drill or plastic spinning handle, and when the sticks 10, 10′ are placed next to a vacuum cleaner roller brush and rotated, they quickly and conveniently clean off the hair and fibrous material that commonly accumulates on household vacuums.

In the illustrative embodiments described above, the cleaning device 10, 10′ uses the hook portion of a hook-and-loop textile fastener material (e.g., the hook portion of Velcro®), not as a fastener system, but in a unanticipated way as a cleaning element creating unexpected results, not by attaching the hook-and-loop fastener material flat to a surface as prescribed by the fastener system, but rather by wrapping the hook portion of a hook-and-loop textile fastener material into a tight circle onto a stiff rod, which creates a continuous hooking surface as it is rotated, with the hooks hitting the hair on the vacuum roller in a perpendicular orientation while spinning the rod with a rotating appliance, such as a drill or spinning handle. The micro-hooks of the hook-and-loop material spinning in a horizontal plane will hook the hair and fibers which are wrapped onto the vacuum roller in a vertical plane. This hooking action is similar to a grappling hook when it is thrown over a rope and pulled to capture the rope. The tough, thermoset monofilament nylon micro-hooks of the hook-and-loop material will hold onto the vacuum roller hair and thread debris just as securely as the hook portion holds onto its mated loop portion of the hook-and-loop material. As the cleaning stick 10, 10′ is rotated by a drill or hand crank handle, the “grappled” hair fibers are pulled and wrapped around the circumference of the stick 10, 10′ as the hair and/or thread fibers break, and are pulled off the vacuum roller. As the spinning cleaning stick 10, 10′ wraps the hair debris, it adds pull strength, which is similar to a tug of war participant when they wrap the rope around their arm in order to create more holding/pulling force and to prevent slippage.

In other embodiments, the plurality of protruding elements of the elongated rod of the cleaning device may comprise other suitable forms. For example, in other embodiments, the plurality of protruding elements of the elongated rod are in the form of a plurality of injection-molded micro-hook elements configured to grab and collect the hair and/or debris from the rotary brush being cleaned. In these other embodiments, the plurality of injection-molded micro-hook elements may be in the form of inverted J-shaped projections and T-shaped projections protruding outwardly from the elongated body of the cleaning device. The plurality of injection-molded micro-hook elements may be disposed on opposite first and second sides of the elongated body of the cleaning device. As one example, two rows of injection-molded micro-hook inverted J-shaped elements may be provided on each side of the elongated body of the cleaning device, while one row of injection-molded micro-hook T-shaped elements may be provided on each of the top and bottom of the elongated body of the cleaning device. Also, the injection-molded micro-hook inverted J-shaped elements that are disposed on the first side and the second side of the elongated body of the cleaning device may be arranged in rows where every other injection-molded micro-hook element points in an opposite direction (i.e., the injection-molded micro-hook elements point in alternating directions along the length of the elongated body). In addition, in these other embodiments, the injection-molded micro-hook inverted J-shaped elements that are disposed on the first side and the second side of the elongated body of the cleaning device may comprise two rows of micro-hook elements with free ends that point in generally opposite directions (e.g., refer to FIGS. 10-12 in U.S. Pat. No. 10,857,577, the entire disclosure of which is incorporated herein by reference).

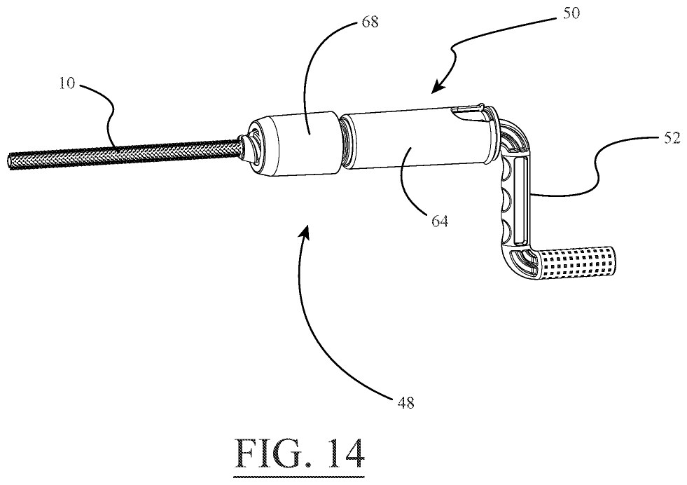

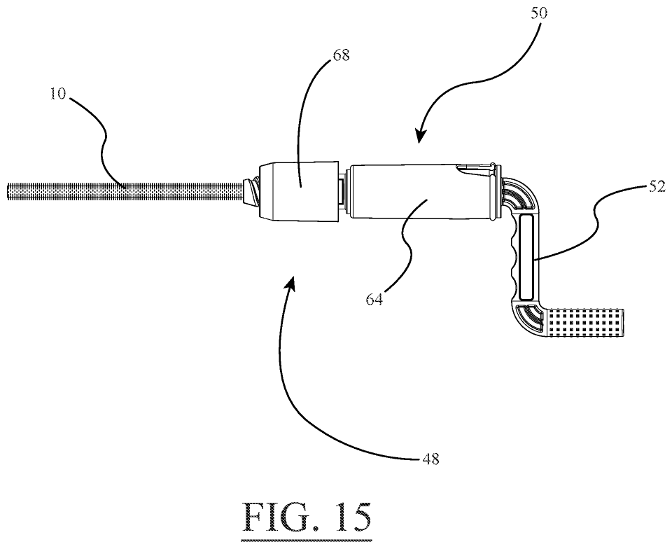

A second illustrative embodiment of a rotary cleaning system is seen generally at 48 in FIGS. 14 and 15. As shown in these figures, in the second illustrative embodiment, the rotary cleaning system 48 comprises the cleaning device 10 and a first type of manual handle assembly 50. As such, in the second illustrative embodiment, a user manually turns the handle 52 of the handle assembly 50 to impart rotary motion to the cleaning device 10. In FIGS. 14 and 15, it can be seen that the first end 12 of the elongated rod of the cleaning device 10 is coupled to the mandrel 68 of the manual handle assembly 50 so that a user is able to pivot the elongated rod of the cleaning device 10 about the rod axis by rotating the handle 52.

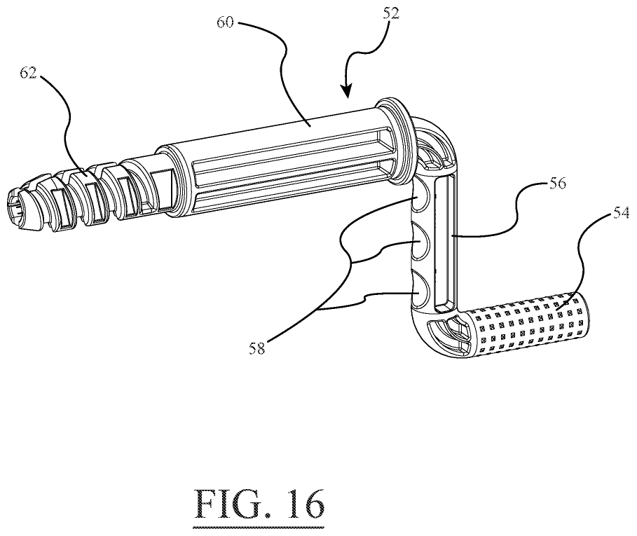

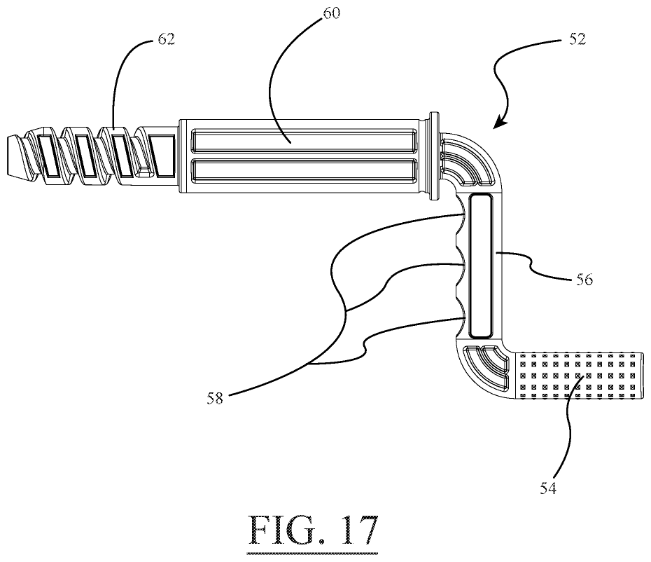

Turning again to FIGS. 14 and 15, it can be seen that the illustrative manual handle assembly 50 generally comprises a handle collet subassembly 52, a sleeve 64, and a mandrel 68. The handle collet subassembly 52 of the manual handle assembly 50 is illustrated in further detail in FIGS. 16 and 17. As shown in these figures, the handle collet subassembly 52 comprises an upper handle portion 54 that is connected to a lower handle portion 60 by a connecting portion 56. In the illustrative embodiment, the upper and lower handle portions 54, 60 have central axes that are disposed generally parallel to one another, and the connecting portion 56 has a central axis that is disposed generally perpendicular to the upper handle portion 54 and the lower handle portion 60. Also, as shown in FIGS. 16 and 17, the connecting portion 56 has a plurality of finger recesses 58 formed therein for accommodating the fingers of a user. The handle collet subassembly 52 further comprises a stick gripping portion 62 at the distal end of the lower handle portion 60.

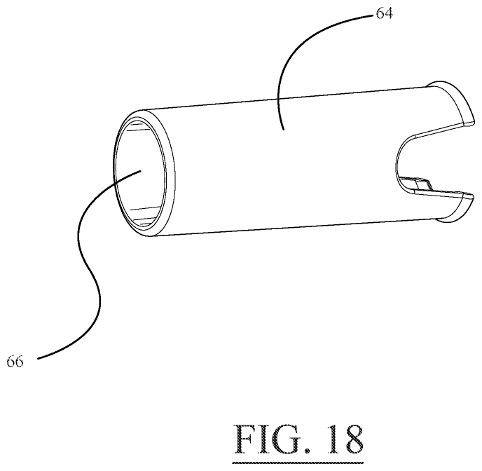

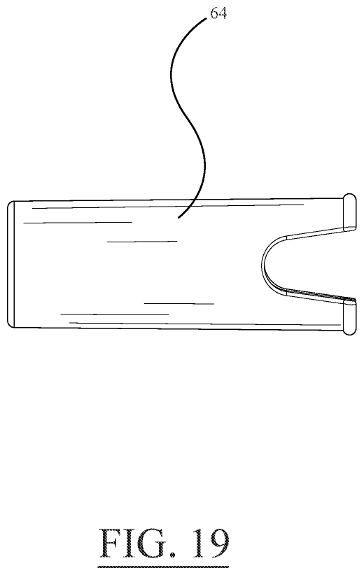

A detail view of the sleeve 64 of the illustrative manual handle assembly 50 is shown in FIGS. 18 and 19. As shown in these figures, the sleeve 64 is provided with a central aperture 66 so as to allow the sleeve 64 to be slipped over the lower handle portion 60 of the handle collet subassembly 52. When the handle 52 is rotated by a user, the sleeve 64 is designed to be held stationary by one hand of the user such the handle collet subassembly 52 rotates relative to the sleeve 64.

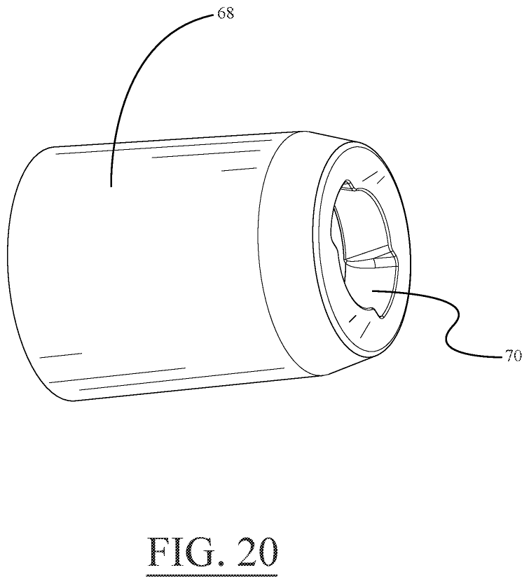

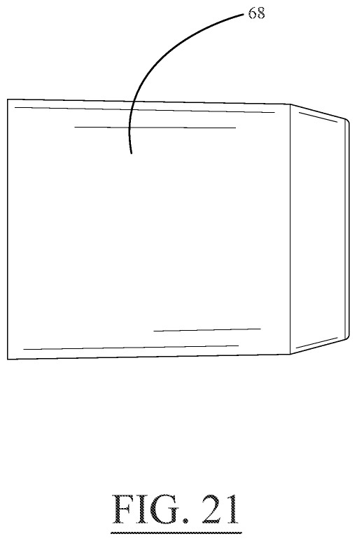

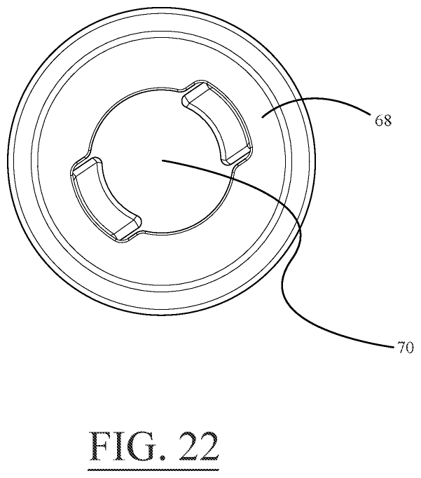

A detail view of the mandrel 68 of the illustrative manual handle assembly 50 is shown in FIGS. 20-22. As shown in these figures, the mandrel 68 is provided with a central aperture 70 so as to allow the mandrel 68 to be fitted onto the stick gripping portion 62 of the handle collet subassembly 52. Once the cleaning device 10 is inserted into the recess in the end of the stick gripping portion 62, the mandrel 68 is able to be tightened by a user so that the stick-like cleaning device 10 is securely held in place within the stick gripping portion 62 (i.e., the mandrel 68 operates as a tightening collar for the manual handle assembly 50).

Now, with reference to FIGS. 12 and 13, an illustrative cleaning application for the cleaning device 10, 10′ described above will be explained. As shown in FIGS. 12 and 13, the rotary brush 44 of the vacuum cleaner 42 contains hair and other debris 46 disposed therearound, which acts to undesirably impede the desired rotation of the rotary brush 44. In order to remove this hair and other debris 46 from the rotary brush 44 of the vacuum cleaner 42, a user initially inserts a cleaning device 10 into the chuck 36 of the battery-powered drill 34, and then tightens the jaws of the drill chuck 36 onto the cleaning device 10 using the tightening collar of the chuck 36. Then, the cleaning device 10 is inserted into the rotary brush 44 in close proximity to the hair and other debris 46, and the cleaning device 10 is rotated about its central axis by activating the drill 34. As the cleaning device 10 is rotated by the drill 34, the plurality of protruding elements 24 of the elongated rod of the cleaning device 10 engage with the hair and other debris 46 in the rotary brush 44 of the vacuum cleaner 42 so as to clean the rotary brush 44. As shown in FIGS. 12 and 13, after cleaning the rotary brush 44 of the vacuum cleaner 42, the cleaning device 10 collects hair and other debris 38′ on the distal end thereof.

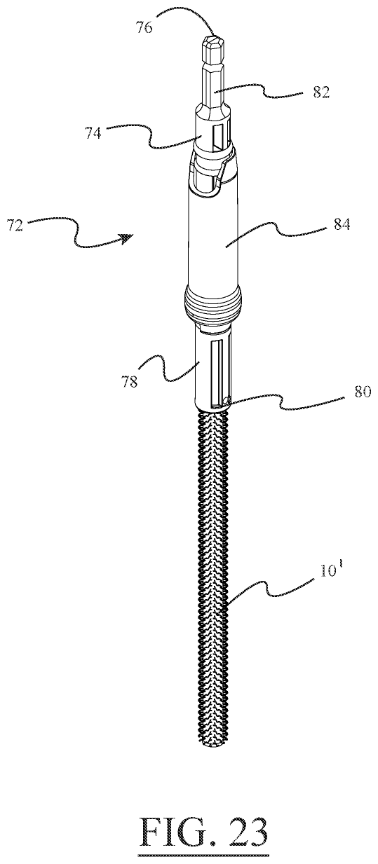

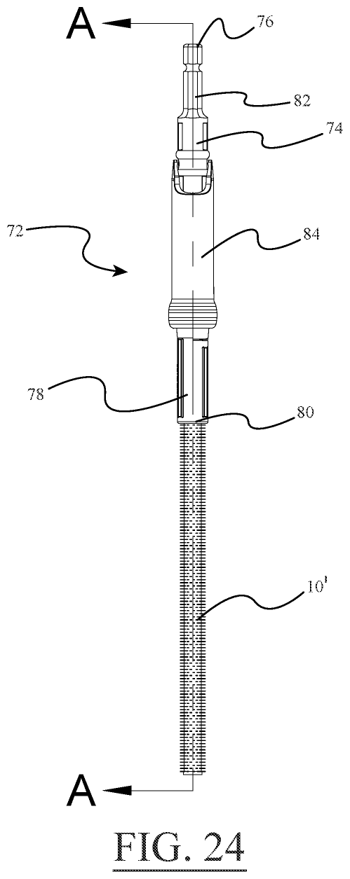

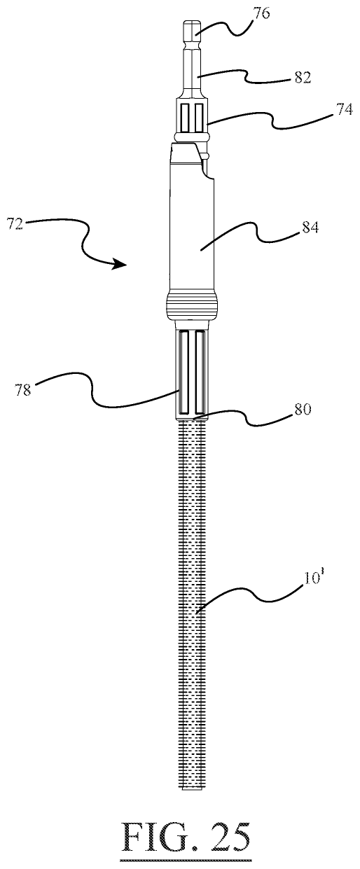

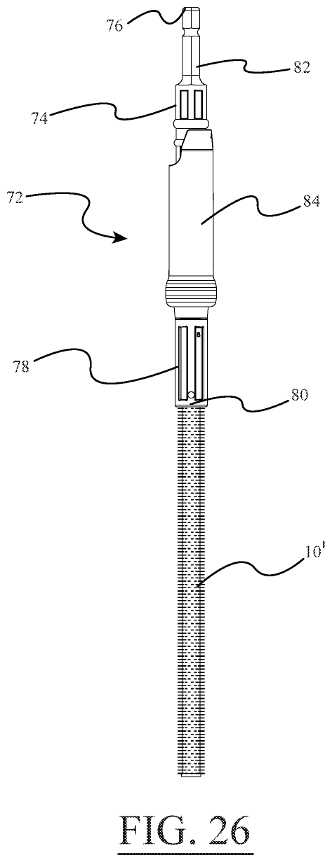

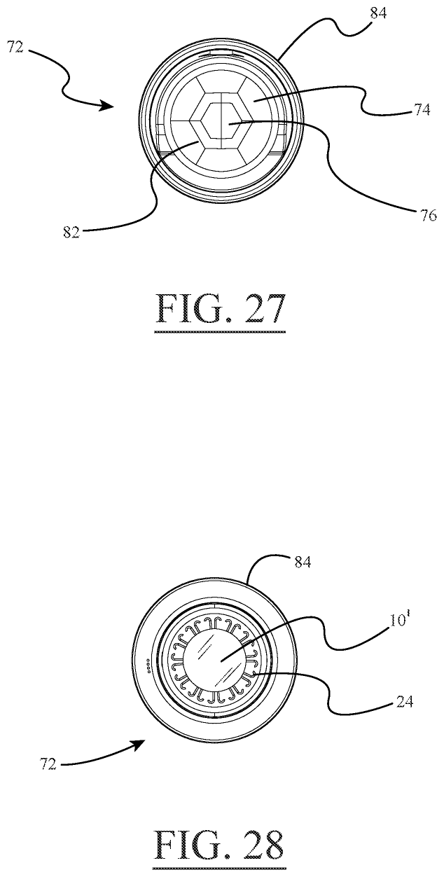

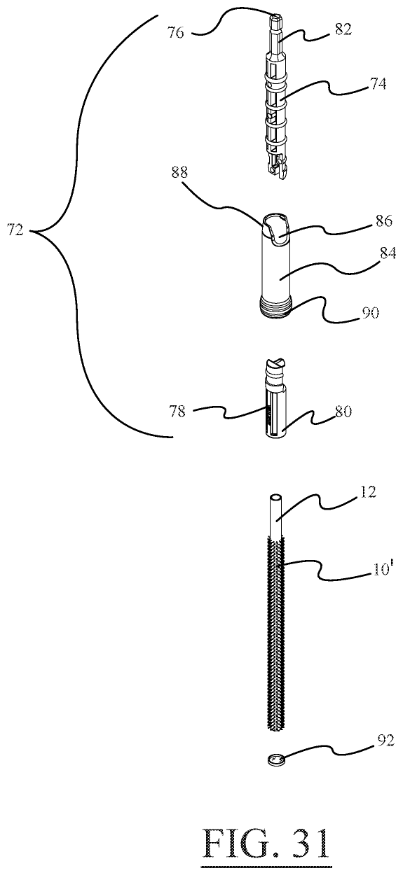

A third illustrative embodiment of a rotary cleaning system is illustrated in FIGS. 23-31. As shown in these figures, in the third illustrative embodiment, the rotary cleaning system comprises the cleaning device 10′ described above and a power tool adapter 72. In this illustrative embodiment, the power tool adapter 72 may be reusable, and may be configured to couple the proximal end of the cleaning device 10′ to a rotary motion input device (e.g., a drill). Referring initially to FIGS. 23 and 31, it can be seen that the power tool adapter 72 includes an adapter body 74 with a shank section 82 for being inserted into a recess of the rotary motion input device (e.g., the drill 34 in FIG. 1). The cleaning device 10′ is attached to the power tool adapter 72 by engagement of the proximal end portion (i.e., the end that is closest to the person when operating the device) of the cleaning device 10′ being engaged with distal end portion of the power tool adapter 72. A slidable sleeve member 84 is shown in its fully engaged configuration in FIG. 23. The sleeve member 84 in this engaged position ensures that the cleaning device 10′ and power tool adapter 72 are fully engaged, i.e., interlocked at their corresponding ends, and the device is ready for use, such as for cleaning a rotary brush of a vacuum cleaner.

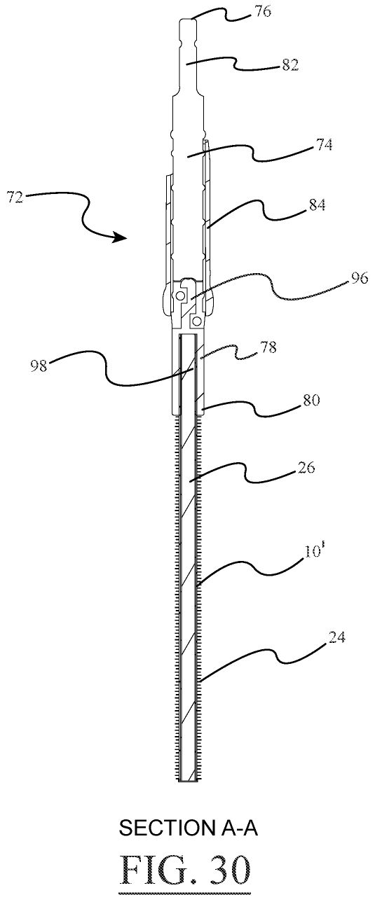

In the illustrative embodiment, as shown in FIG. 23, the power tool adapter 72 generally comprises a body section 74 with a proximal end portion 76 and a connector section 78 with the distal end portion 80, the proximal end portion 76 of the body section 74 being oppositely disposed relative to the distal end portion 80 of the connector section 78. In FIG. 23, it can be seen that the distal end portion 80 of the connector section 78 is configured to be coupled to the proximal end portion of the cleaning device 10′. More specifically, as shown in the sectional view of FIG. 30, the connector section 78 is provided with a cylindrical bore 98 for receiving the proximal end portion of the cleaning device 10′ (e.g., the proximal end of the cleaning device 10′ may be affixedly secured in the cylindrical bore 98 by a suitable adhesive or glue). In the illustrative embodiment, the proximal end portion 76 of the adapter body section 74 is configured to be coupled to a rotary motion input device (e.g., a drill 34—see FIG. 1) that is sufficient to rotate the plurality of protruding elements 24 of the elongated rod of the cleaning device 10′ about the rod axis so as to grab and collect the hair and/or debris from a rotary vacuum brush so as to clean the rotary brush. As shown in FIG. 31, the distal end of the cleaning device 10′ may be provided with an end cap 92 to cover the exposed end of the elongated rod of the cleaning device 10′ (e.g., the end cap 92 may be glued on the distal end of the elongated rod of the cleaning device 10′).

In the illustrative embodiment, as shown in FIG. 23, it can be seen that the proximal end portion 76 of the adapter body 74 of the power tool adapter 72 comprises a shank section 82 for being inserted into a recess of the rotary motion input device (e.g., the drill 34 in FIG. 1). For example, the rotary motion input device for rotating the cleaning device 10′ may comprise a drill, a screwdriver, a power drill, or a power screwdriver. In the illustrative embodiment, the power tool adapter is configured for use with a drill, and the shank section at the proximal end portion of the adapter body is in a form of a drill bit shank section 82 for being inserted into a drill chuck recess. In the illustrative embodiment of FIG. 23, the drill bit shank section 82 has a generally hexagonal cross-sectional shape for being inserted into the drill chuck recess. In another embodiment, the drill bit shank section may have a generally circular cross-sectional shape for being inserted into the drill chuck recess.

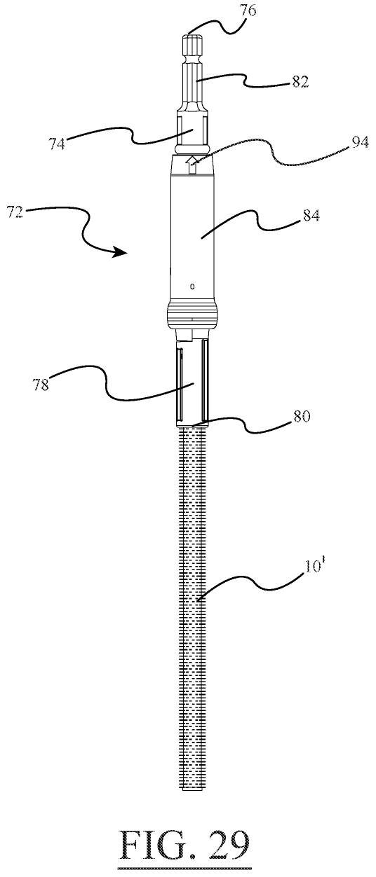

In the illustrative embodiment, as will be described in further detail hereinafter, a user inserts the drill bit shank section 82 into a drill and tightens the chuck in the same fashion as using a drill bit. The slidable sleeve member 84 moves axially along the center of the power tool adapter between an engaged position (i.e., a locking position) and a disengaged position (i.e., a release position). This sliding action of the sleeve member 84 fully engages or releases the replaceable cleaning device 10′ and the connector section 78, which attaches to the distal end portion of the power tool adapter body 74. Once the drill bit shank section 82 of the power tool adapter is locked into the drill chuck, the user grasps the drill in one hand and the spinning sleeve member 84 with the other hand, and inserts the attached cleaning device 10′ into a rotary vacuum brush so as to clean hair and/or debris from the rotary brush. Then, the user simply runs the drill on slow speed and allows the drill to power the cleaning device 10′. The user can then detach the removable cleaning device 10′ and the connector section 78 of the cleaning device 10′ by sliding the spinning sleeve 84 of the power tool adapter up toward the proximal drill end (in the pointing direction of arrow 94 in FIG. 29), exposing the mated, interlocking ends of both the adapter body 74 and the connector section 78 attached to the cleaning device 10′ (see FIG. 31), thereby allowing for removal and replacement of the cleaning device 10′.

In the illustrative embodiment, the sleeve member 84 of the power tool adapter 72 can be moved back and forth between two possible positions along the adapter body 74: (i) a disengaged position where the connector section 78 attached to the cleaning device 10′ is able to be released from the power tool adapter 72, and (ii) an engaged position where the distal end portion of the adapter body 74 is locked into engagement with the connector section 78 attached to the cleaning device 10′. The sleeve member 84 of the power tool adapter has a proximal end 88 and a distal end 90 (see FIG. 31).

After use, the cleaning device 10′ and the attached connector section 78 are disengaged from the power tool adapter 72 (as described below) and can be discarded in an appropriate disposal receptacle, or in an appropriate recycling collection container.

In the illustrative embodiment, the sleeve member 84 of the power tool adapter has a generally cylindrical shape, but may include a notch 86 at its proximal end 88 (see FIG. 31). When the sleeve member 84 is moved backward to its disengaged position, the interlocking ends of the connector section 78 at the proximal end of the cleaning device 10′ and the distal end portion of the power tool adapter 72 are exposed and can be detached.

In the illustrative embodiment, the cleaning device 10′ and the attached connector section 78 are preferably disposable. The power tool adapter 72 is preferably reusable and can be made of a suitably durable material (e.g., a suitable plastic) to withstand repeated engagement and disengagement with the connector section 78 at the proximal end of the cleaning device 10′ and repeated use.

Now, with reference to the illustrative embodiment of FIGS. 23-31, the manner in which the cleaning device 10′ is attached to a driving power tool (e.g., a drill 34) will be explained. First of all, the drill bit shank section 82 of the power tool adapter 72 is inserted into the chuck of the battery-powered drill by a user, and then the user tightens the jaws of the drill chuck onto the drill bit shank section 82 of the power tool adapter 72 using the tightening collar of the chuck. Secondly, the user slides the sleeve member 84 of the power tool adapter 72 into its disengaged position. Then, the user engages the connector section 78 at the proximal end of the cleaning device 10′ with the distal end portion of the power tool adapter 72. More specifically, with reference to the illustrative embodiment of FIG. 30, the zigzag mating protrusion 96 of the connector section 78 is inserted into a corresponding recess in the distal end portion of power tool adapter body 74. Finally, once the connector section 78 at the proximal end of the cleaning device 10′ is engaged with the distal end portion of the power tool adapter 72, the user slides the sleeve member 84 into its engaged position so as to secure the connector section 78 at the proximal end of the cleaning device 10′ to the power tool adapter 72.

When the cleaning device 10′ is in the fully engaged configuration, the cleaning device 10′ is ready for use. The cleaning device 10′ can be inserted into a rotary vacuum brush to clean the hair and/or other debris therefrom. The user then places one hand on the sleeve member 84 of the power tool adapter 72 and uses the other hand to hold the drill. Pressing the trigger on the drill causes the cleaning device 10′ to rotate inside the clogged rotary vacuum brush, thereby removing obstructing materials. The power tool adapter 72 can be turned indefinitely to rotate the cleaning device 10′, thereby continuously collecting debris at the distal end of the cleaning device 10′.

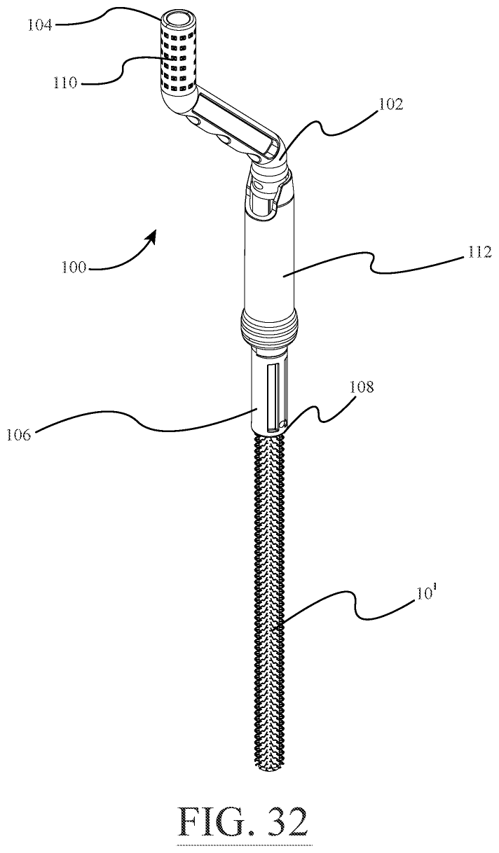

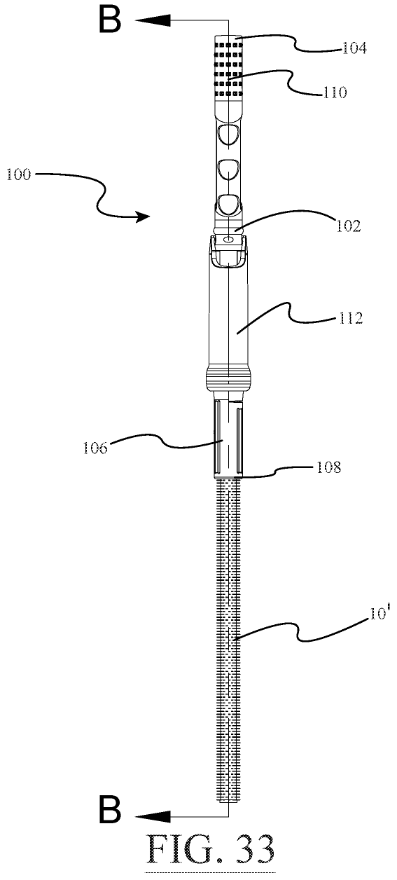

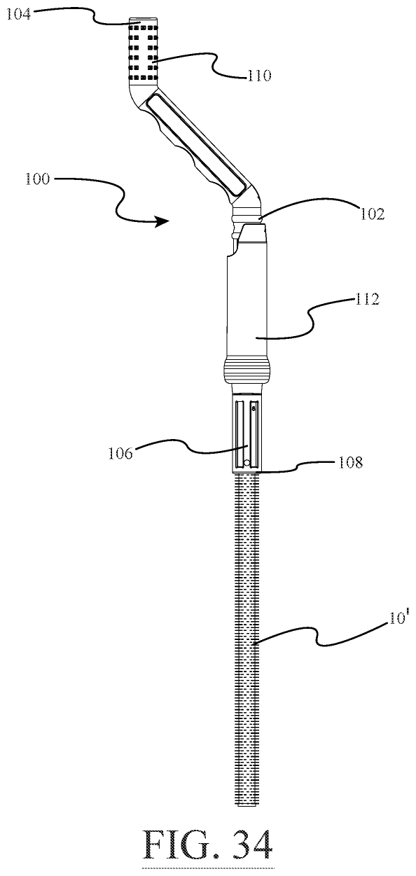

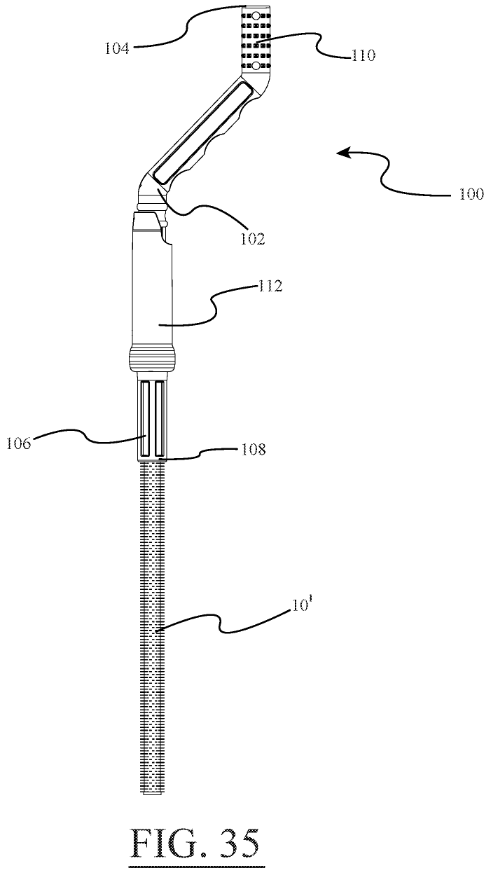

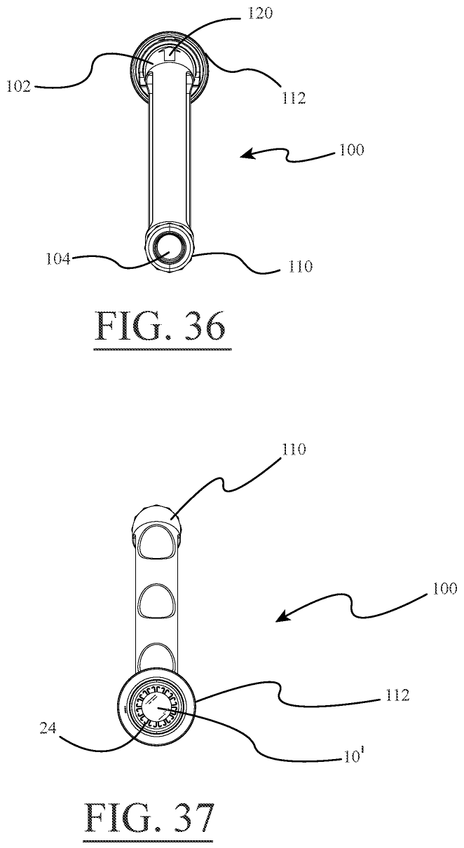

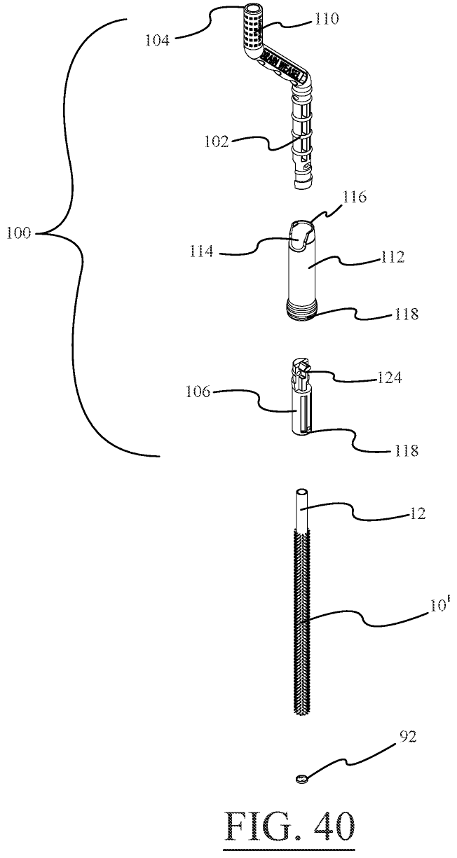

A fourth illustrative embodiment of a rotary cleaning system is illustrated in FIGS. 32-40. As shown in these figures, in the fourth illustrative embodiment, the rotary cleaning system comprises the cleaning device 10′ described above and a second type of manual handle assembly 100. As such, similar to the second illustrative embodiment described above, a user manually turns the handle section 110 of the handle assembly 100 to impart rotary motion to the cleaning device 10′. In this illustrative embodiment, the manual handle assembly 100 may be reusable, and may be configured to be coupled to the proximal end of the cleaning device 10′. Referring initially to FIGS. 32 and 40, it can be seen that the manual handle assembly 100 includes a handle body 102 with a handle section 110 for being manually rotated by a user. The cleaning device 10′ is attached to the manual handle assembly 100 by engagement of the proximal end portion (i.e., the end that is closest to the person when operating the device) of the cleaning device 10′ being engaged with distal end portion of the handle assembly 100. A slidable sleeve member 112 is shown in its fully engaged configuration in FIG. 32. The sleeve member 112 in this engaged position ensures that the cleaning device 10′ and the handle assembly 100 are fully engaged, i.e., interlocked at their corresponding ends, and the device is ready for use, such as for cleaning a rotary brush of a vacuum cleaner.

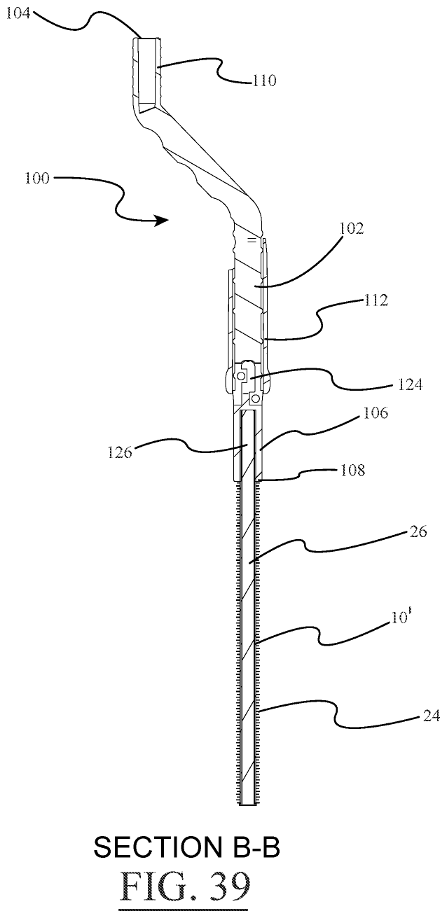

In the illustrative embodiment, as shown in FIG. 32, the manual handle assembly 100 generally comprises a handle body 102 with a proximal end portion 104 and a connector section 106 with the distal end portion 108, the proximal end portion 104 of the handle body 102 being oppositely disposed relative to the distal end portion 108 of the connector section 106. In FIG. 32, it can be seen that the distal end portion 108 of the connector section 106 is configured to be coupled to the proximal end portion of the cleaning device 10′. More specifically, as shown in the sectional view of FIG. 39, the connector section 106 is provided with a cylindrical bore 126 for receiving the proximal end portion of the cleaning device 10′ (e.g., the proximal end of the cleaning device 10′ may be affixedly secured in the cylindrical bore 126 by a suitable adhesive or glue). In the illustrative embodiment, the proximal end portion 104 of the manual handle assembly 100 is configured to be grasped and rotated by a user in order to rotate the plurality of protruding elements 24 of the elongated rod of the cleaning device 10′ about the rod axis, thereby grabbing and collecting the hair and/or debris from a rotary vacuum brush so as to clean the rotary brush. As shown in FIG. 40, the distal end of the cleaning device 10′ may be provided with an end cap 92 to cover the exposed end of the elongated rod of the cleaning device 10′ (e.g., the end cap 92 may be glued on the distal end of the elongated rod of the cleaning device 10′).

In the illustrative embodiment, as shown in FIG. 32, it can be seen that the handle body 102 of the manual handle assembly 100 generally comprises a top cylindrical handle portion 110 and a diagonal middle portion that comprises a plurality of finger concave recesses or indentations for accommodating fingers of the user when the cleaning device 10′ is being inserted into, and removed from a rotary vacuum brush (e.g., the handle body 102 of the manual handle assembly 100 may be similar to the handle section 102 in FIGS. 19-26 of co-pending U.S. patent application Ser. No. 17/556,852, the entire disclosure of which is incorporated herein by reference).

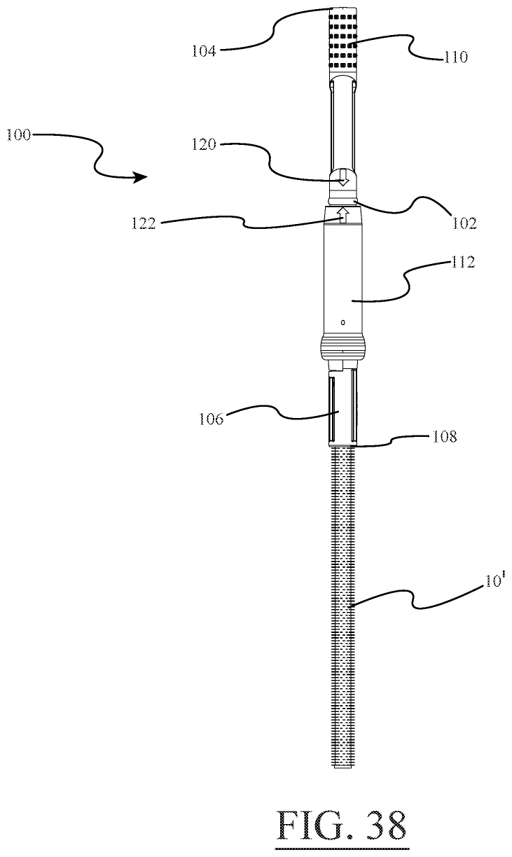

In the illustrative embodiment, the slidable sleeve member 112 moves axially along the center of the manual handle assembly 100 between an engaged position (i.e., a locking position) and a disengaged position (i.e., a release position). This sliding action of the sleeve member 112 fully engages or releases the replaceable cleaning device 10′ and the connector section 106, which attaches to the distal end portion of the manual handle assembly 100. When performing a cleaning operation, the user grasps the handle portion 110 in one hand and the spinning sleeve member 112 with the other hand, and inserts the attached cleaning device 10′ into a rotary vacuum brush so as to clean hair and/or debris from the rotary brush. The user can then detach the removable cleaning device 10′ and the connector section 106 of the cleaning device 10′ by sliding the spinning sleeve 112 of the manual handle assembly 100 up toward the proximal handle end (in the pointing direction of arrow 122 in FIG. 38), exposing the mated, interlocking ends of both the handle body 102 and the connector section 106 attached to the cleaning device 10′ (see FIG. 40), thereby allowing for removal and replacement of the cleaning device 10′.

In the illustrative embodiment, the sleeve member 112 of the manual handle assembly 100 can be moved back and forth between two possible positions along the handle body 102: (i) a disengaged position where the connector section 106 attached to the cleaning device 10′ is able to be released from the manual handle assembly 100, and (ii) an engaged position where the distal end portion of the handle body 102 is locked into engagement with the connector section 106 attached to the cleaning device 10′. The sleeve member 112 of the power tool adapter has a proximal end 116 and a distal end 118.

After use, the cleaning device 10′ and the attached connector section 106 are disengaged from the manual handle assembly 100 (as described below) and can be discarded in an appropriate disposal receptacle, or in an appropriate recycling collection container.

In the illustrative embodiment, the sleeve member 112 of the manual handle assembly 100 has a generally cylindrical shape, but may include a notch 114 at its proximal end 116 (see FIG. 40). When the sleeve member 112 is moved backward to its disengaged position, the interlocking ends of the connector section 106 at the proximal end of the cleaning device 10′ and the distal end portion of the manual handle assembly 100 are exposed and can be detached.

In the illustrative embodiment, the cleaning device 10′ and the attached connector section 106 are preferably disposable. The manual handle assembly 100 is preferably reusable and can be made of a suitably durable material (e.g., a suitable plastic) to withstand repeated engagement and disengagement with the connector section 106 at the proximal end of the cleaning device 10′ and repeated use.

Now, with reference to the illustrative embodiment of FIGS. 32-40, the manner in which the cleaning device 10′ is attached to the manual handle assembly 100 will be explained. First of all, the user slides the sleeve member 112 of the manual handle assembly 100 into its disengaged position (by sliding the sleeve member 112 in the pointing direction of arrow 122 in FIG. 38). Then, the user engages the connector section 106 at the proximal end of the cleaning device 10′ with the distal end portion of the handle body 102 of the manual handle assembly 100. More specifically, with reference to the illustrative embodiment of FIGS. 39 and 40, the zigzag mating protrusion 124 of the connector section 106 is inserted into a corresponding recess in the distal end portion of the handle body 102. Finally, once the connector section 106 at the proximal end of the cleaning device 10′ is engaged with the distal end portion of the handle body 102 of the manual handle assembly 100, the user slides the sleeve member 112 into its engaged position (by sliding the sleeve member 112 in the pointing direction of arrow 120 in FIG. 38) so as to secure the connector section 106 at the proximal end of the cleaning device 10′ to the manual handle assembly 100.

When the cleaning device 10′ is in the fully engaged configuration, the cleaning device 10′ is ready for use. The cleaning device 10′ can be inserted into a rotary vacuum brush to clean the hair and/or other debris therefrom. The user then places one hand on the sleeve member 112 of the manual handle assembly 100 and uses the other hand to rotate the cleaning device 10′ using the handle portion 110. The manual handle assembly 100 can be turned indefinitely to rotate the cleaning device 10′, thereby continuously collecting debris at the distal end of the cleaning device 10′.

In the illustrative embodiment, the cleaning device 10, 10′ is configured to be discarded after being used to remove the hair and/or debris from the rotary brush. For example, as shown in FIG. 2, a plurality of cleaning devices 10 may be provided in a multipack so that a used one of the cleaning devices 10 may be swapped out with a new, unused cleaning device 10 (e.g., the used cleaning device 10 of FIG. 2 in the drill 34 with hair and other debris 38 thereon may be removed from the drill 34, and replaced with one of the unused cleaning devices 10 lying next to the drill 34 in FIG. 2).

In one or more embodiments, the cleaning device 10, 10′ may be configured to be flipped end-for-end and reused after being used to remove the hair and/or debris from the rotary brush (e.g., from the rotary brush 44 of the vacuum cleaner 42 in FIGS. 12 and 13). Also, in one or more embodiments, the cleaning device 10, 10′ may be configured to be trimmed and reused after being used to remove the hair and/or debris from the rotary brush (e.g., from the rotary brush 44 of the vacuum cleaner 42 in FIGS. 12 and 13).

It is readily apparent that the aforedescribed cleaning device 10, 10′ offers numerous advantages. For example, cleaning device 10, 10′ is able to easily and safely remove hair and/or debris from a rotary brush, such as a vacuum roller brush.

As described above, an entirely unexpected result is produced when the hook portion of a hook-and-loop fastener material (e.g., the hook portion of Velcro®) is combined with a rotational appliance (e.g., a drill or manual handle) so as to produce an entirely new and effective vacuum roller cleaner. When hair and other debris is wrapped and attached around the tight diameter of the properly-sized roller cleaning stick 10, 10′ a grappling force is created that is stronger than the strength of the wrapped hair and carpet thread debris, thereby allowing the cleaning sticks 10, 10′ to grapple, break and wrap the debris in a fast, continuous fluid circular motion so as create a new, faster, safer, and more effective tool and method for cleaning a rotary brush (e.g., a vacuum roller brush).

Any of the features or attributes of the above described embodiments and variations can be used in combination with any of the other features and attributes of the above described embodiments and variations as desired.

Although the invention has been shown and described with respect to a certain embodiment or embodiments, it is apparent that this invention can be embodied in many different forms and that many other modifications and variations are possible without departing from the spirit and scope of this invention.

Moreover, while exemplary embodiments have been described herein, one of ordinary skill in the art will readily appreciate that the exemplary embodiments set forth above are merely illustrative in nature and should not be construed as to limit the claims in any manner. Rather, the scope of the invention is defined only by the appended claims and their equivalents, and not, by the preceding description.

The invention claimed is:

1. A cleaning device for removing hair and/or debris from a rotary brush, the cleaning device comprising:
an elongated rod having a first end, a second end, and a rod axis, the first end of the elongated rod being oppositely disposed relative to the second end of the elongated rod, the elongated rod further including a plurality of protruding elements projecting outwardly from the elongated rod, the plurality of protruding elements being disposed at least partially around a periphery of the elongated rod and along at least a portion of a length of the elongated rod between the first end and the second end;
wherein the first end of the elongated rod is configured to be coupled to a rotary motion input device that is sufficient to rotate the plurality of protruding elements of the elongated rod about the rod axis; and
whereby, upon the elongated rod being rotated by the rotary motion input device, the plurality of protruding elements are configured to grab and collect the hair and/or debris from the rotary brush so as to clean the rotary brush.

2. The cleaning device according to claim 1, wherein the rotary motion input device for rotating the elongated rod is selected from the group consisting of: (i) a drill, (ii) a screwdriver, (iii) a power drill, (iv) a power screwdriver, and (v) a hand crank.

3. The cleaning device according to claim 1, wherein the elongated rod further comprises a central core portion and an outer covering bonded to the central core portion, the outer covering formed from a hook material strip, the hook material strip comprising the plurality of protruding elements of the elongated rod, and the hook material strip being made from a hook side of a hook-and-loop fastener material.

4. The cleaning device according to claim 3, wherein the central core portion is formed from a semi-flexible cable, the semi-flexible cable comprising a plurality of inner wires surrounded by an outer sheathing, the hook material strip being bonded to the outer sheathing of the semi-flexible cable.

5. The cleaning device according to claim 3, wherein the central core portion is formed from a plastic core.

6. The cleaning device according to claim 1, wherein the plurality of protruding elements of the elongated rod are in the form of a plurality of injection-molded micro-hook elements.

7. The cleaning device according to claim 6, wherein at least some of the plurality of injection-molded micro-hook elements are in the form of inverted J-shaped projections projecting outwardly from the elongated rod.

8. The cleaning device according to claim 6, wherein at least some of the plurality of injection-molded micro-hook elements are in the form of T-shaped projections projecting outwardly from the elongated rod.

9. The cleaning device according to claim 1, wherein the rotary brush is a rotary brush in a vacuum cleaner.

10. The cleaning device according to claim 1, wherein:
the cleaning device is configured to be discarded after being used to remove the hair and/or debris from the rotary brush;
the cleaning device is configured to be trimmed and reused after being used to remove the hair and/or debris from the rotary brush; or
the cleaning device is configured to be flipped end-for-end and reused after being used to remove the hair and/or debris from the rotary brush.

11. The cleaning device according to claim 1, further comprising a power tool adapter configured to couple the first end of the elongated rod section to the rotary motion input device, the power tool adapter includes an adapter body with a shank section for being inserted into a recess of the rotary motion input device.

12. The cleaning device according to claim 1, wherein the rotary motion input device is in a form of a manual handle assembly, the manual handle assembly configured to be detachably coupled to the elongated rod so that the cleaning device is able to be discarded after being used to remove the hair and/or debris from the rotary brush.

13. A cleaning device for removing hair and/or debris from a rotary brush, the cleaning device comprising:
an elongated rod having a first end, a second end, and a rod axis, the first end of the elongated rod being oppositely disposed relative to the second end of the elongated rod, the elongated rod further including a plurality of protruding elements projecting outwardly from the elongated rod, the plurality of protruding elements being disposed at least partially around a periphery of the elongated rod and along at least a portion of a length of the elongated rod between the first end and the second end; and
a rotary motion input device coupled to the first end of the elongated rod, the rotary motion input device configured to rotate the elongated rod about the rod axis;
whereby, upon the elongated rod being rotated by the rotary motion input device about the rod axis, the plurality of protruding elements of the elongated rod are configured to grab and collect the hair and/or debris from the rotary brush so as to clean the rotary brush.

14. The cleaning device according to claim 13, wherein the rotary motion input device is selected from the group consisting of: (i) a drill, (ii) a screwdriver, (iii) a power drill, (iv) a power screwdriver, and (v) a hand crank.

15. The cleaning device according to claim 13, wherein the elongated rod further comprises a central core portion and an outer covering bonded to the central core portion, the outer covering formed from a hook material strip, the hook material strip comprising the plurality of protruding elements of the elongated rod, and the hook material strip being made from a hook side of a hook-and-loop fastener material.

16. The cleaning device according to claim 15, wherein the central core portion is formed from a semi-flexible cable, the semi-flexible cable comprising a plurality of inner wires surrounded by an outer sheathing, the hook material strip being bonded to the outer sheathing of the semi-flexible cable.

17. The cleaning device according to claim 15, wherein the central core portion is formed from a plastic core.

18. The cleaning device according to claim 13, wherein the rotary brush is a rotary brush in a vacuum cleaner.

19. The cleaning device according to claim 13, further comprising a power tool adapter configured to couple the first end of the elongated rod section to the rotary motion input device, the power tool adapter includes an adapter body with a shank section for being inserted into a recess of the rotary motion input device.

20. The cleaning device according to claim 13, wherein the rotary motion input device is in a form of a manual handle assembly, the manual handle assembly configured to be detachably coupled to the elongated rod so that the cleaning device is able to be discarded after being used to remove the hair and/or debris from the rotary brush.
